(19) United States
(12) Patent Application Publication
(10) Pub. No.: US 2015/0066559 A1
(43) Pub. Date: Mar. 5, 2015

(54) College Planning System, Method and Article

(71) Applicant: James Robert Brouwer, Interlochen, MI (US)

(72) Inventor: James Robert Brouwer, Interlochen, MI (US)

(21) Appl. No.: 14/199,383

(22) Filed: Mar. 6, 2014

Related U.S. Application Data
(60) Provisional application No. 61/774,644, filed on Mar. 8, 2013.

(51) Int. Cl. G06Q 50/20; G06Q 10/10

(52) U.S. Cl. CPC G06Q 50/2053; G06Q 10/1097
USPC 705/7.21; 705/327

(57) ABSTRACT

A computer-implemented college and career planning system is provided comprising a dynamic graphical user interface customized based upon user personal profile data and/or user system use data; an interface engine comprising a processor for matching post-secondary education institution content with a user based upon user supplied search terms, the user personal profile data and/or the user system use data; meta-knowledge rule bases for storing rules for filtering system data for a user; long-term memory editorial for being matched to users based upon the meta-knowledge rule base, user personal profile and user system use; moderated forums for user-to-user communications organized by topic; feedback forums for providing feedback regarding the editorial content, the editorial topics evolving based upon system use; a toolbox comprising worksheets configured for accepting user input data; and a module for vetting the editorial content prior to making the editorial content available for matching.

### CLAIM OF PRIORITY

This application claims priority to and the benefit of the filing date of provisional application, U.S. Ser. No. 61/774,644, filed on Mar. 8, 2013.

### FIELD

This patent application relates to college planning.

### BACKGROUND

High school students and parents face many sources of information in planning for post-secondary education. Colleges and universities present academic admissions and financial aid marketing information to attract applicants. High school counselors and other advisors may offer advice regarding high school coursework, extra curricular activities, admission related testing, and other academic advice geared toward increasing a student's chance of admission, as well as college placement information, but may be limited in their knowledge and/or experience with frequently changing aspects of admissions practices, student life, and academic offerings of various colleges. Financial aid information for federal, state, and private sources may be provided for funding post-secondary education. Additionally, there are deadlines associated with various events, tests, pre-admissions, and admissions steps that may be recommended for students and parents for gaining information regarding college options, admissions processes, obtaining funding, and the like. Keeping track of this information, compiling it, and making useful sense of it may be difficult. Accordingly, there is a need for a centralized forum for providing college planning and admissions related data from multiple sources.

There exist computerized systems for universities to identify and target potential student applicants. Such systems may include functionality for tracking student/university interactions, track student profile information (such as GPA and test scores), and allow for a university to target market to potential student applicants and track marketing efforts. Such system typically may assist a university in finding qualified applicants, but may not assist applicants in evaluating colleges and universities to find a good fit for the student's needs, abilities, and desires.

Systems for sending student transcripts and/or application information to one or more universities are known. Such computerized systems may automate transmissions of transcripts and/or application information electronically to one or more universities of a student's selection. But such systems lack information concerning admissions deadlines and lack educational materials to offer student's information concerning the admission process, academic and financial planning, the differences between various colleges and universities, and the various considerations one should examine when evaluating offer options.

Systems for students and/or parents to use for college planning, including ranking potential colleges and universities based upon those institutions' self-reported data and applicant survey information, and providing financial planning information are known. Such systems purport to find best fit matches for a student and university based upon student profile information entered by the applicant. However, known systems rank universities based upon pre-set criteria and do not allow a student or parent user to supply their own criteria and weight it.

Sometimes a college ready student and/or their parent does not believe that (s)he is qualified to attend post-secondary education. Sometimes a student and/or parent is of the belief they cannot afford any post-secondary education. Sometimes a potential applicant of post-secondary education is not certain of what type of university (s)he wants, would be successful in, and/or should be targeting with applications. Sometimes a student and/or parent of a potential college student is not aware of different considerations associated with post-secondary education choices, such as by way of example, degree programs, student satisfaction, travel costs, financial aid options, academic life, social life, environment, and other considerations. For example, a student in a Maine high school may not have considered how few times the student may be able to travel home if attending a school in Hawaii, due to travel expenses and/or time. Sometimes an applicant is unaware of the timing and steps needed and/or recommended for successful admission application. For example, a student applicant may not be aware of admission interview timing, application deadlines and/or follow-up steps recommended for a successful admission. Student rankings of potential universities may be limited based upon information known to the applicant and the applicant may not consider of one or more universities that may have provided a good or better fit due to information missing from that applicant's knowledge base.

High school or other counselors may provide college counseling to students and/or parents regarding admissions steps, decision-making, decision-making criteria or considerations, or ideas, or advice regarding post-secondary education. Yet, this is generally done with an ad hoc approach that may differ greatly counselor-by-counselor and school-by-school. A student may miss a piece of advice that (s)he would find valuable due to his or her particular high school not having any counseling personnel or counseling personnel with knowledge of a piece of pertinent information and/or not applying a particular piece of information to a particular student. For example, a mid-western high school counselor may be more versed in mid-western post-secondary education institutions and not have as much information enabling advice for southeastern institutions that offer stronger programs in a given field. A counselor may not view a particular student as having qualifications to attend a particular university, or a specific university being a good fit for that student, and accordingly not provide the student with information about certain potential university choices based upon that counselor's single viewpoint. A counselor is

often unaware of additions or deletions to an institutions admission standards or curriculum and degree offerings that would otherwise significantly impact their considered advice.

Accordingly, there exists a need for a college planning tool that provides post-secondary education information to potential applicants, that provides multiple counseling viewpoints to potential students and parents regarding college admissions criteria and considerations when evaluating post-secondary institutions. There is a need to provide students and parents with an individualized “path to college,” including information concerning admissions criteria, timing, and suggestions for admissions success. There is a need in the art to provide students and parents information concerning colleges and universities that presents possible considerations, criteria or admissions decision-making factors in a manner that is not biased toward a particular university choice, and which does not rank possible selections for students, but communications considerations and criteria for a user to evaluate that is personalized. There exists a need in the art for a forum for counselors and/or others to offer advice of varying viewpoints to applicants regarding post-secondary education considerations, and for such people to provide such advice to many applicants in an automated and centralized manner with a computerized system, which is capable of matching editorial content to system users based upon user profile information and system use history, and also allows for a more broad-based audience to view such information.

There is a need in the art for an admissions calendaring tool which may be customized for a particular user and accept multi-media entries from colleges, student, parents, counselors, sponsors, and others.

### SUMMARY

What is provided is a computerized system, method, and article for providing information, editorial content, and counseling to students and parents regarding post-secondary education choices, considerations, admissions processes, financial aid information, and deadlines associated therewith. In various examples, the system may include post-secondary education institution information, user profile information, user system use information, editorial content, educational content, counseling information, calendaring for testing and admissions timeline and/or deadline requirements, one or more social networking forums for communication between users and/or contributors, and matching functionality for matching users to content. For example, the system may include functionality for matching student users to applicable advice, educational content, editorial content and/or university information based upon personal profile information and/or system use.

The system includes one or more tools or worksheets for users to use in acting upon recommended tasks for college admission decision-making. For example, the system may create a student planner, course planner, personal academic record, posted portfolio (student profile information published for institution viewing), personal college search criteria document, college search worksheet (to organize and display search results), college visit checklist, budget work sheet, financial aid worksheet, college fit worksheet, application materials, offer evaluation worksheet, packing list for what to take to school, and/or other documents.

The system includes vetted content and user supplied content. Vetted content may be supplied by the system or users, and undergoes a vetting process to determine appropriateness of the content and to assign one or more tags to the content that may be used to match content to users. User supplied content may include forum entries or blog inputs. Content may be text, audio, video or multimedia based in form.

The system includes a database of university information including information about university programs, scholarships, athletics, campus life, admissions criteria, geographic area (i.e. urban, rural, etc.) and other information. The post-secondary education institution information may be entered by the universities and/or retrieved from neutral third party sources.

The system includes a student database of demographic and survey obtained information about student applicants, including information such as grades, test scores, athletics, accomplishments, activities, geographic region, likes/desires, etc. Profile information may include user input information, including data input from other users such as high school teachers, coaches, directors, and others. It may include multi-media content, such as text, audio, image, video and various combinations thereof. The system allows for users to elect what information from a user profile may be shared with others, such as institutions, via privacy settings. The privacy settings may allow for different information to be shared with different types of third parties and/or customized on a case-by-case basis, such as providing information only to specific institutions that the user selects.

The system allows for users to enter their own criteria for institution selection, and does not merely limit users to pre-set criteria. For example, a student applicant may seek to find institutions where she may bring her horse to school with her. She may enter this criteria information into the system. The system includes matching functionality for matching students to universities having characteristics and programs as identified by the student.

The system includes matching functionality for allowing universities to find potential applicants having skills or qualities that the university seeks. Universities may search for potential applicants based upon user input profile information, as allowed by the user input privacy settings.

Matching functionality includes filtering options that are customizable, for filtering available hits. Filtering may be available for student/parent user searches for institutions and institution searches for student applicants. The system is customizable and allows users to select and build their own filtering criteria, rather than provide ranked institution matches based solely upon set criteria.

The system also includes educational and counseling functions that allow for users to contribute editorial content, advice and/or information, and assign one or more topic areas to the advice or information. Contributors may be college and university professionals, high school counselors, coaches, teachers, students, parents, alumnae, business professionals, and other system users. The system is capable of matching editorial content to system users, based upon tagging the content, and matching it to user profile information and/or user system use history. Editorial content may be categorized, bookmarked, saved, stored and/or recalled for viewing by the user.

The system includes functionality for assisting users in evaluating college offers based upon user input criteria, objective criteria regarding college offerings, financial aid information, offer components, and/or other information.

The system includes admissions calendaring functionality, capable of providing a calendar customizable for a particular user, which may accept multi-media input from multiple sources, such as universities, counselors, students, parents and others. Calendar content may include admissions deadline data, college visit data, college nights or other admissions related events, entrance exam testing deadlines, financial aid deadlines, early admission deadlines, and/or other dates.

The system may include sponsor users and provide sponsor advertisements, promotions or other content to system users, in a targeted manner based upon personal profile information and/or system use.

The system may include application completion functionality for electronically transmitting student information to one or more institution applications electronically. This may include student and/or financial information for academic admissions and financial aid applications.

The system may include admissions preparation components. It may include functionality for conducting a mock admissions interview to prepare a student for the admissions process. It may include decision follow through functionality including recommended actions to take to follow up on applications, acceptances and the like. For example, the system may optionally provide thank you notes, declination letters and/or acceptance letters for students and/or families to send to institutions via the system.

### BRIEF DESCRIPTION OF THE DRAWINGS

Subject matter is particularly pointed out and distinctly claimed in the concluding portion of the specification. Claimed subject matter, however, as to structure, organization and method of operation, together with objects, features, and advantages thereof, may best be understood by reference to the following detailed description if read with the accompanying drawings in which:

FIG. 1 is a schematic showing an example college planning system in accordance with the present application;

FIG. 2 is a diagram showing possible uses and features of a college planning system in accordance with the present application;

FIG. 3 is a flow diagram showing an editorial content vetting method;

FIG. 4 is a screen shot from an example customizable user interface of an example college planning system; and

FIG. 5 is a flow chart describing an example method of searching for colleges with the present system.

### DETAILED DESCRIPTION

In the following detailed description, numerous specific details are set forth in order to provide a thorough understanding of the technology as defined in the claimed subject matter, and as an example of how to make and use the technology. However, it will be understood by those skilled in the art that claimed subject matter is not intended to be limited to such specific details and may even be practiced without requiring such specific details. In other instances, well-known methods, procedures, and components have not been described in detail so as not to obscure the technology defined by the claimed subject matter.

Some portions of the detailed description that follow are presented in terms of algorithms and/or symbolic representations of operations on data bits and/or binary digital signals stored within a computing system, such as within a computer and/or computing system memory. These algorithmic descriptions and/or representations are the techniques used by those of ordinary skill in the data processing arts to convey the substance of their work to others skilled in the art. An algorithm is here and generally considered to be a self-consistent sequence of operations and/or similar processing leading to a desired result. The operations and/or processing may involve physical manipulations of physical quantities. Typically, although not necessarily, these quantities may take the form of electrical and/or magnetic signals capable of being stored, transferred, combined, compared, and/or otherwise manipulated. It has proven convenient at times, principally for reasons of common usage, to refer to these signals as bits, data, values, elements, symbols, characters, terms, numbers, numerals and/or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining,” and/or the like refer to the actions and/or processes of a computing platform, such as a computer or a similar electronic computing device that manipulates and/or transforms data represented as physical electronic and/or magnetic quantities and/or other physical quantities within the computing platform's processors, memories, registers, and/or other information storage, transmission, and/or display devices.

Unless specifically stated otherwise, as apparent from the following discussion, it is appreciated that throughout this specification a computing platform includes, but is not limited to, a device such as a computer or a similar electronic computing device that manipulates and/or transforms data represented as physical, electronic, and/or magnetic quantities and/or other physical quantities within the computing platform's processors, memories, registers, and/or other information storage, transmission, reception, and/or display devices. Accordingly, a computing platform refers to a system, a device, and/or a logical construct that includes the ability to process and/or store data in the form of signals. Thus, a computing platform, in this context, may comprise hardware, software, firmware, and/or any combination thereof. Where it is described that a user instructs a computing platform to perform a certain action, it is understood that instructs may mean to direct or cause to perform a task as a result of a selection or action by a user. A user may, for example, instruct a computing platform to embark upon a course of action via an indication of a selection, including, for example, pushing a key, clicking a mouse, maneuvering a pointer, touching a touch screen, and/or by audible sounds. A user may, for example, input data into a computing platform such as by pushing a key, clicking a mouse, maneuvering a pointer, touching a touch pad, touching a touch screen, acting out touch screen gesturing movements, maneuvering an electronic pen device over a screen, verbalizing voice commands and/or by audible sounds. A user may include an end-user.

Flowcharts, also referred to as flow diagrams by some, are used in some figures herein to illustrate certain aspects of some examples. Logic they illustrate is not intended to be exhaustive of any, all, or even most possibilities. Their purpose is to help facilitate an understanding of this disclosure with regard to the particular matters disclosed herein. To this end, many well-known techniques and design choices are not repeated herein so as not to obscure the teachings of this disclosure.

Throughout this specification, the term system may, depending at least in part upon the particular context, be understood to include any method, process, apparatus, and/or other patentable subject matter that implements the subject matter disclosed herein.

Although the example presented in this application is directed towards a college planning system, other possible uses and applications are possible for the functionality subject matter described herein and are contemplated within the scope and spirit of this application. For example, the matching functionality, customizable user interface display, editorial content vetting method, editorial content categorization and display techniques and the like may be used in applications beyond a college planning system.

For example, this system may be used as a career planning system. Issues which affect career choices, editorial which relates to careers, and matching functionality related to career fields may be used in this application as a career planning system alongside of or independent of using it as a college planning system. For example, a high school student stating interest in becoming an architect would receive editorial suggesting she take advanced math courses during her 11th or 12th grade year in order to meet prerequisite entrance requirements for colleges offering degree majors in architecture. For example, a high school student stating an interest in a skilled trade would receive editorial providing advice on how to contact local businesses and trade associations in order to explore the opportunities of that field or enter an apprentice program. For example, a user could participate in a self-directed audit of personal characteristics designed to help them focus on a career path. Many other career related exercises and editorial examples exist which could be used independently or in conjunction with college planning system 10.

For example, the matching functionality, customizable user interface display, editorial content vetting method, editorial content categorization and display techniques and the like may be used in applications beyond a college planning system. Unless specifically stated, claimed subject matter is not intended to be limited to a college planning system use for these and other features. Further, as used herein, the terms “college” or “university” is not intended to be limited to a particular type of post-secondary institution, but may include universities, colleges, junior colleges, trade schools, and other places for studying skills and/or obtaining professional degrees or certifications. The use of such terms herein is intended to be interchangeable and non-limiting.

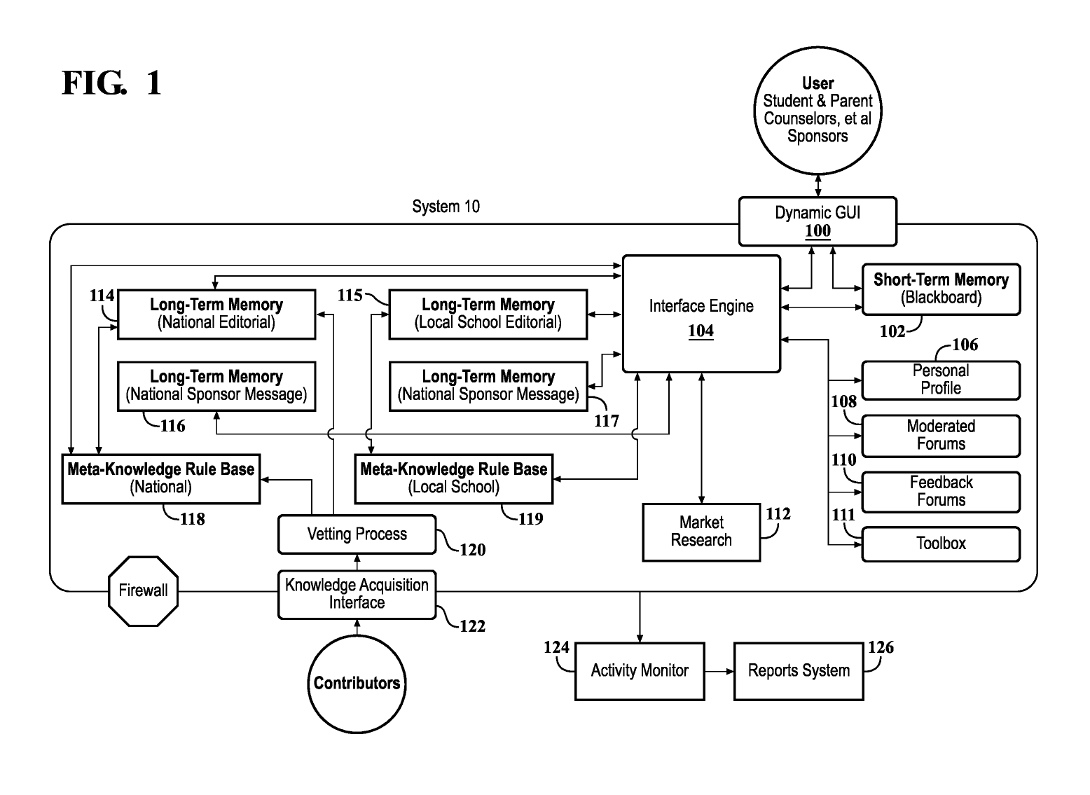

Referring to FIG. 1, college planning system 10 is shown. A user of system 10 may experience different user interface displays, depending upon the user's personal profile information, use of system 10, and/or the user's progression through various aspects of college planning. Dynamic graphical user interface (GUI) 100 is a portal with which users may access system 10. Dynamic GUI 100 may display user specific information and be customized for a particular user based upon that user's personal profile information and/or system use. Dynamic GUI 100 may include template content for a student user, which differs from a parent user, an admissions user, a counselor user, an advertising sponsor user, a business professional user and/or another user. Within that template content, different substantive content may be displayed for different users, based upon personal profile information and/or system use and/or system use history. Dynamic GUI 100 may access short-term memory 102, for operations including, but not limited to, preparing and/or displaying user specific content. This may be referred to as blackboard functionality.

System 10 may include and/or be accessed by one or more user devices capable of tangibly displaying dynamic GUI 100. Such user devices may be used to input data such as personal profile data, editorial content, sponsor messages, rules, filtering criteria, report information, and/or other data. A user device may be a computing platform, as described in this application, such as a computing device, desktop computer, laptop computer, tablet, mobile device, handheld device, PDA, cellular device, smartphone, scanner, or any other device known in the art that is capable of displaying dynamic GUI 100, and/or inputting text, audio, video and/or other data. The user device may be capable of accepting user input data, such as data from student or parent users, college representatives, admissions professionals, contributors, sponsors, counselors, and/or other users. The user device may be used to upload data, such as personal profile data, editorial content, sponsor messages, rules, filtering criteria, report information, and/or other data, to a server via a wired, wireless, remote and/or other network, such as a server of or associated with interface engine 104.

One or more user devices may be capable of computing, running, updating and/or saving one or more personal profiles, editorial contents, sponsor messages, rules, matching methods, reports and/or other data queries, as described with respect to FIGS. 1-5. In other examples, these functions may be performed by a database server and/or memory. The user device may be capable of receiving data from system 10 for display, such as a display from dynamic GUI 100, and/or in some examples, computing one or more operations or functions based at least in part upon personal profile data, user system use, editorial content, sponsor messages, rules, matching criteria, reports and/or other data, based at least in part upon the data received.

Dynamic GUI 100 may be viewable on a user device display. A display may comprise a video display adapter having components, including, for example, video memory, a buffer, and/or a graphics engine. Such video memory may comprise, for example, video random access memory (VRAM), synchronous graphics random access memory (SGRAM), windows random access memory (WRAM), and/or the like. A display for viewing dynamic GUI 100 may comprise a cathode ray-tube (CRT) type display such as a monitor and/or television and/or may comprise an alternative type of display technology such as a projection type CRT type display, a liquid-crystal display (LCD) projector type display, an LCD type display, a light-emitting diode (LED) type display, a gas and/or plasma type display, an electroluminescent type display, a vacuum fluorescent type display, a cathodoluminescent and/or field emission type display, a plasma addressed liquid crystal (PALC) type display, a high gain emissive display (HGED) type display, and so forth. A display may include a touchscreen tablet or mobile device display.

The user device, such as a computing platform, may include one or more I/O devices, such as a keyboard, touch screen, stylus, electroacoustic transducer, microphone, speaker, audio amplifier, and/or the like. These may be used to input data into system 10. The computing platform may include an external interface, which may comprise one or more controllers and/or adapters to prove interface functions between multiple I/O devices. For example, an external interface may comprise a serial port, parallel port, universal serial bus (USB) port, charge coupled device (CCD) reader, scanner, compact disc (CD), compact disk read-only memory (CD-ROM), digital versatile disc (DVD), video capture device, Television tuner card, 802×3 devices, and/or IEEE 1394 serial bus port, infrared port, network adapter, printer adapter, radio-frequency (RF) communications adapter, universal asynchronous receiver-transmitter (UART) port, and/or the like, to interface between corresponding I/O devices. Claimed subject matter is not intended to be limited to this particular example of a computing platform tangibly embodying one or more processes, features or aspects of the system, user interface and methods described herein.

System 10 includes interface engine 104, which is capable of engaging related databases and retrieving materials from memory for presentation upon GUI 100, based upon data from short-term memory 102 and user selections. Interface engine 104 may coordinate one or more rules from meta-knowledge rule base national 118, to filter system data, such as but not limited to editorial content, for a particular user. Interface engine 104 may interface with personal profile 106, which is capable of storing data regarding and/or input by one or more users, imported into system 10 and/or provided by system 10.

Interface engine 104 may include and/or communicate with a database server, with may communicate with a web server over a network. The database server may be integral to interface engine 104 in some examples. The communications network may be any combination of wired and/or wireless LAN, cellular and/or Internet communications and/or other local and/or remote communications networks known in the art.

Interface engine 104 may include one or more processors for matching editorial content with users, such as counseling content, university information, educational content, financial aid information, and the like. Such a processor may comprise a central processing unit such as a microprocessor or microcontroller for executing programs, performing data manipulations, and controlling the tasks of system 10 and/or a computing platform tangibly embodying one or more processes, functions or features or system 10. Auxiliary processors may manage input/output, perform floating point mathematical operations, manage digital signals, perform fast execution of signal processing algorithms, operate as a back-end processor and/or a slave-type processor subordinate to processor, operate as an additional microprocessor and/or controller for dual and/or multiple processor systems, and/or operate as a coprocessor and/or additional processor. Such auxiliary processors may be discrete processors and/or may be arranged in the same package as a main processor, for example, in a multicore and/or multithreaded processor; however, the scope of the scope of claimed subject matter is not limited in these respects.

Communication with a processor may be implemented via a bus (not shown) for transferring information among the components of a computing platform tangibly embodying one or more methods, features and/or functions of system 10. A bus may include a data channel for facilitating information transfer between storage and other peripheral components of a computing platform. A bus may further provide a set of signals utilized for communication with a processor, including, for example, a data bus, an address bus, and/or a control bus. A bus may comprise any bus architecture according to promulgated standards, for example, industry standard architecture (ISA), extended industry standard architecture (EISA), micro channel architecture (MCA), Video Electronics Standards Association local bus (VLB), peripheral component interconnect (PCI) local bus, PCI express (PCIe), hyper transport (HT), standards promulgated by the Institute of Electrical and Electronics Engineers (IEEE) including IEEE 488 general-purpose interface bus (GPIB), IEEE 696/S-100, and others. Claimed subject matter is not limited in this respect.

These examples are not intended to be limiting. In some examples, interface engine 104 may be a database server, and/or include one or more databases and/or memory.

Personal profile 106 may comprise user data, such as but not limited to, user identification data, such as but not limited to: name, address, user type (student, adult student, parent, grandparent, high school director, high school coach, high school teacher, high school administrator, high school counselor, independent counselor, college counselor, college admissions person, advertiser, mentor, business professional, and others) and other demographic information. Personal profile 106 may include other user educational information, such as but not limited to, current school of attendance, grade level, entrance exam test score information, financial information, student expectations, abilities, and desires for type of college/degree program, planned course of study, student/work scheduling, other desired attributes of a post-secondary program, and/or other information. Personal profile 106 may include college preference information, activities, and other information. Personal profile 106 may include professional information and experience (such as field of counseling for counselor users), high school identifying information (such as for high school administration or faculty users), college identifying information (such as for college admissions users), financial institution identifying information (such as for college funding sources), parent demographic information (for parent and guardian users), sponsor information (such as for sponsor users) and/or other information. Personal profile 106 may include information concerning how the user wishes to use system 10 (i.e. what assistance they seek on the path to college; what services the user would like to access through the system, etc.). Personal profile 106 may include data input by the user via electronic surveys and/or forms, and/or imported into system 10 from one or more external sources. It may include data provided by system 10. Personal profile 106 may include user selections regarding privacy, restrictions upon use or display of personal profile information (which may be separate for one or more information categories or institutions), marketing research or surveys that the user selects for participation, system notification and use selections, and the like. Personal profile 106 may include information regarding calendaring options and user selections of same, such as calendaring desired by event category or topic, and/or for individual events. For example, a user could elect to be notified about college entrance testing dates and associated review course dates, admissions deadlines, financial aid application deadlines, and/or college visits. Optionally, the system may allow for customized reminders regarding deadlines and dates calendared, which may be user selected. System content that is viewable and/or available to a user may be triggered by content in personal profile 106. For example, certain functions of system 10 may not be available to a user unless the user supplies a minimum level of information in personal profile 106.

Interface engine 104 may interface with one or more moderated forums 108. Moderated forums 108 include one or more forums where users may enter content and dialogue with other users. Moderated forums 108 may be monitored and content vetted by system 10, such as for inappropriate content or language. Alternatively and/or in addition, moderated forums 108 may be monitored externally to system 10 by one or more editors. Moderated forums 108 may contain functionality for allowing users to flag or report objectionable content. Moderated forums 108 may be topic based, such as but not limited to, financial aid tips, college admission requirements, student life, university athletic programs, 9^{th} grader steps to take to increase admissions chances, and many others are possible.

Interface engine 104 interfaces with feedback forums 110, which includes one or more forums where users may enter content to provide feedback regarding editorial pieces or other system content. Feedback forums 110 may be organized by one or more editorial content topics, which may evolve based upon system use. For example, feedback forums may include campus tour feedback, student or alumni evaluation of colleges, financial aid feedback, financial scam feedback, advanced placement course feedback, college admission policy feedback, and many others. Feedback forums 110 may be monitored for inappropriate content. Feedback forums 110 may include user opinion content for one or more particular subjects, user ratings for specific subjects, such as a reviewed product or service. Rating criteria may be supplied by system 10. Ratings and evaluations may be displayed with user information from the user's personal profile (such as, by way of example, GPA, grade level, geographical location or other information) to assist a viewer in assessing relevancy of the rating or opinion.

Moderated forums 108 and/or feedback forums 110 may allow for interactive exchange of posts or messaging content. They may also include one or more topic based blogs, such as a blog having a student “maven” supplying the content.

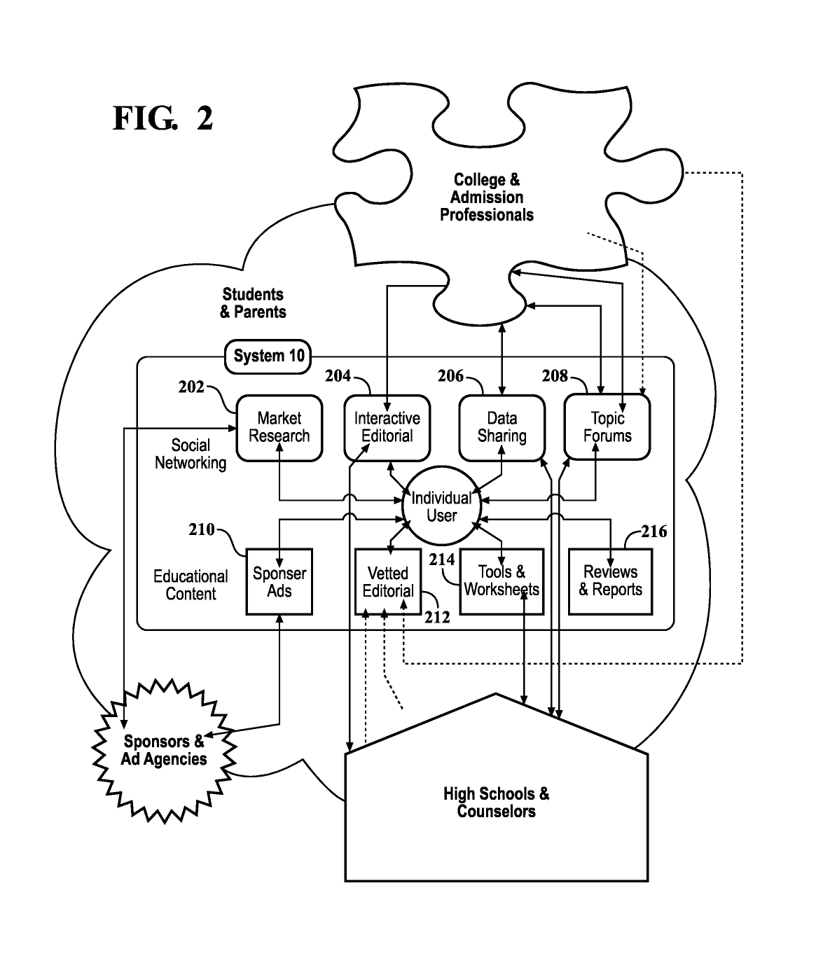

Interface engine 104 interfaces with toolbox 111. Toolbox 111 provides users with a variety of worksheets and various tools to assist them in reaching their individual goals. For example, the academic chronicle is a series of worksheets that build on each other, which may allow high school students to plan their courses, track their grades, and keep track of other matters relevant to pursuing higher education. For example, the selection criteria worksheet may provide students the ability to define specific features they would like to add to a college search that are otherwise missing from standard search lists while also having the ability to assign varying levels of importance to each item. For example, the budget and financial aid worksheets provide a modifiable outline of budgeting considerations along with fields that aggregate and project expected expenses. Many more examples of toolbox items exist, some of which are described in more detail below in the discussion of tools and worksheets 214 of FIG. 2.

Interface engine 104 interfaces with market research 112. Market research 112 may allow for users to participate in market research activities, such as based upon opt-in participation settings selected in the personal profile 106. Primary marketing research surveys and other data may be entered into system 10 by sponsor users or others. Interface engine 104 is capable of two-way communications with short-term memory 102, personal profile 106, moderated forums 108, feedback forums 110, toolbox 111 and/or market research 112, for reading, writing, processing and storing data.

System 10 includes long-term memory editorial 114 and 115, which may be used for storing data, such as but not limited to, editorial information and content for system 10. Editorial content may include, by way of example, academic based content, university information, educational content regarding various admissions related topics, counseling content, tools, worksheets and/or other content. It may include calendaring content capable of being personalized for a user to announce admissions deadline information, recommended steps on the path to college, event information and the like. Other content is possible and these are merely a few of the numerous possibilities contemplated. Long-term memory editorial 114 and 115 may be a database in various examples.

Long-term memory national editorial 114 contains data that may be delivered to any user. Long-term memory local school editorial 115 contains data that is entered by a local high school counselor or teacher and may only be accessed by users who attend or are associated with that local high school. For example, all users may be delivered data from long-term memory national editorial 114 that discusses popular myths relating to attending college, but only users attending or associated with a specific local high school may be delivered data from long-term memory local school editorial 115 that discusses a date on which several college representative will be visiting that school's campus. Many other examples exist. Interface engine 104 is capable of two-way communications with long-term memory national editorial 114 and long-term memory local school editorial 115.

System 10 may include long-term memory sponsor message 116 and 117 used for storing sponsor messages, such as advertisements for display to users of system 10. Sponsor messages may be displayed to users based upon data from the user profile 106, user interaction and interaction history with system 10, and/or criteria, as determined by the sponsor. Sponsor content may be displayed in various manners, forms, and formats on GUI 100. Long-term memory sponsor message 116 and 117 may be a database in various examples. Interface engine 104 is capable of two-way communications with long-term memory national sponsor message 116 and long-term memory local sponsor message 117.

Long-term memory national sponsor message 116 contains data that may be delivered to any user. Long-term memory local sponsor message 117 contains data that may only be delivered to users who attend or are associated with a given local high school in which the local sponsor has selected for their ads to run. For example, all users may be delivered data from long-term memory national sponsor message 116 that is promoting a brand of laptop computer, but only users attending a local high school designated by a local sponsor may be delivered data from long-term memory local sponsor message 117 that promotes a discount on an ice-cream sundae at the neighborhood ice-cream stand. Regional sponsors' data is stored in long-term memory national sponsor message 1177. In other examples, long-term memory 114 and/or 115 and 116 and/or 117 may be one memory, and/or various auxiliary memories may be used.

Long-term memory 114 and/or 115, long-term memory 116 and/or 117, and/or short-term memory 102 may be any type of local, remote, auxiliary, flash, cloud or other memory known in the art. Data stored in memory may include, at least in part, data regarding one or more personal profiles, editorial contents, sponsor messages, rules, matching criteria, reports, and/or other data. In some examples, a user device may send data to a database server associated with interface engine 104 via a network for storage in memory.

Long-term memory 114 and/or 115, long-term memory 116 and/or 177, and/or short-term memory 102 may include one or more auxiliary memories (not shown). Long-term memory 114 and/or 115, long-term memory 116 and/or 117, and/or short-term memory 102 may provide storage of instructions and data for one or more programs to be executed by a processor of interface engine 104, such as all or a portion of FIGS. 1-5 and/or other procedures disclosed herein, for example. Long-term memory 114 and/or 115, long-term memory 116 and/or 117, and/or short-term memory 102 may comprise, for example, semiconductor-based memory such as dynamic random access memory (DRAM) and/or static random access memory (SRAM), and/or the like. Other semi-conductor-based memory types may include, for example, synchronous dynamic random access memory (SDRAM), Rambus dynamic random access memory (RDRAM), ferroelectric random access memory (FRAM), and so on. Alternatively or additionally, long-term memory 114 and/or 115, long-term memory 116 and/or 117, and/or short-term memory 102 may comprise, for example, magnetic-based memory, such as a magnetic disc memory, a magnetic tape memory, and/or the like; an optical-based memory, such as a compact disc read write memory, and/or the like; a magneto-optical-based memory, such as a memory formed of ferromagnetic material read by a laser, and/or the like; a phase-change-based memory such as phase change memory (PRAM), and/or the like; a holographic-based memory such as rewritable holographic storage utilizing the photorefractive effect in crystals, and/or the like; a molecular-based memory such as polymer-based memories, and/or the like; and/or a remote or cloud based memory and/or the like. Auxiliary memories may be utilized to store instructions and/or data that are to be loaded into memory before execution. Auxiliary memories may include semiconductor-based memory such as read-only memory (ROM), programmable read-only memory (PROM), erasable programmable read-only memory (EPROM), electrically erasable read-only memory (EEPROM), and/or flash memory, and/or any block oriented memory similar to EEPROM. For example, short-term memory 102 may be of this type. Auxiliary memories also may include any type of non-semiconductor-based memories, including, but not limited to, magnetic tape, drum, floppy disk, hard disk, optical, laser disk, compact disc read-only memory (CD-ROM), write once compact disc (CD-R), rewritable compact disc (CD-RW), digital versatile disc read-only memory (DVD-ROM), write once DVD (DVD-R), rewritable digital versatile disc (DVD-RAM), and so on. Other varieties of memory devices are contemplated as well.

System 10 includes a meta-knowledge rule base 118 and 119, which contains one or more rules that may be used for filtering searches and database content. Meta-knowledge rule base national 118 may be in two-way communication with interface engine 104 and/or long-term memory national editorial 114. Meta-knowledge rule base local school 119 may be in two-way communication with interface engine 104 and/or long-term memory local school editorial 115. For example, meta-knowledge rule base national 118 may include rules for filtering matches between system users and content, such as educational pieces applying to certain types of users, universities having user set criteria, counseling content aimed for a particular audience, and the like. For example, meta-knowledge rule base local school 119 may include rules entered by a specific high school's counselor or teacher that prevents access to information in long-term memory local school editorial 115 until a user who attends or is associated with that particular high school meets certain requirements. Both meta-knowledge rule base 118 and 119 may include rules for providing content to users based upon data from personal profile 106 and/or user system use. For example, meta-knowledge rule base national 118 may designate a module or piece of content for a specific user based upon a student user's grade level, such as a 9^{th} grade user may receive suggestions for further courses to take in high school prior to graduation to increase chances of college admission for a particular degree program; while a 12^{th} grade user may not receive this module of content due to lack of opportunity based upon the timeline until graduation for enrolling in further high school courses. For example, a content module regarding college entrance exams may differ for an 11^{th} grader in the fall than in the spring, based upon testing dates and application deadlines for college entrance exams. For example, recommended steps on the path to college may be different for a high school senior, junior, sophomore and freshman, based upon the time between the system use and anticipated date of college entrance. Content matches may be different for student users and parent users. For example, meta-knowledge rule base local school 119 may designate the availability of a school specific scholarship opportunity that only applies to students attending that high school and would not present this data to students or users associated with other high schools.

Meta-knowledge rule base national 118 is capable of two-way communications with long-term memory national editorial 114 as there may be rules in meta-knowledge rule base national 118 that may alter the data long-term memory national editorial 114 delivers to the user and/or data in long-term memory national editorial 114 that may influence the implementation of a rule contained in meta-knowledge rule base national 118.

Meta-knowledge rule base local school 119 is capable of two-way communications with long-term memory local school editorial 115 as there may be rules in meta-knowledge rule base local school 119 that may alter the data long-term memory local school editorial 115 delivers and/or data in long-term memory local school editorial 115 that may influence the implementation of a rule contained in meta-knowledge rule base national 119. For example, a meta-knowledge rule base practice (national 118 or local school 119) may require a user to view one piece of long-term memory data (corresponding national 114 or local school 115) as a prerequisite to viewing another piece of data. Other examples are possible within the scope and spirit of this application.

In some examples, long-term memory 114 and/or 116 and/or meta-knowledge rule base 118 may include storage of content that may be applicable and displayed for all system 10 users. In some examples, long-term memory 115 and/or 117 and/or meta-knowledge rule base 119 may include storage of content that is only applicable and displayed to specific users, based upon the user's personal profile information that associates them with a specific school. Such local content may be added by counselors, teachers, or others specifically associated with that school as well as advertisements provided by local sponsors that are associated with that specific school. In this manner, system 10 includes functionality that allows one or more counselors (or teachers or others) to make localized modifications for their specific school.

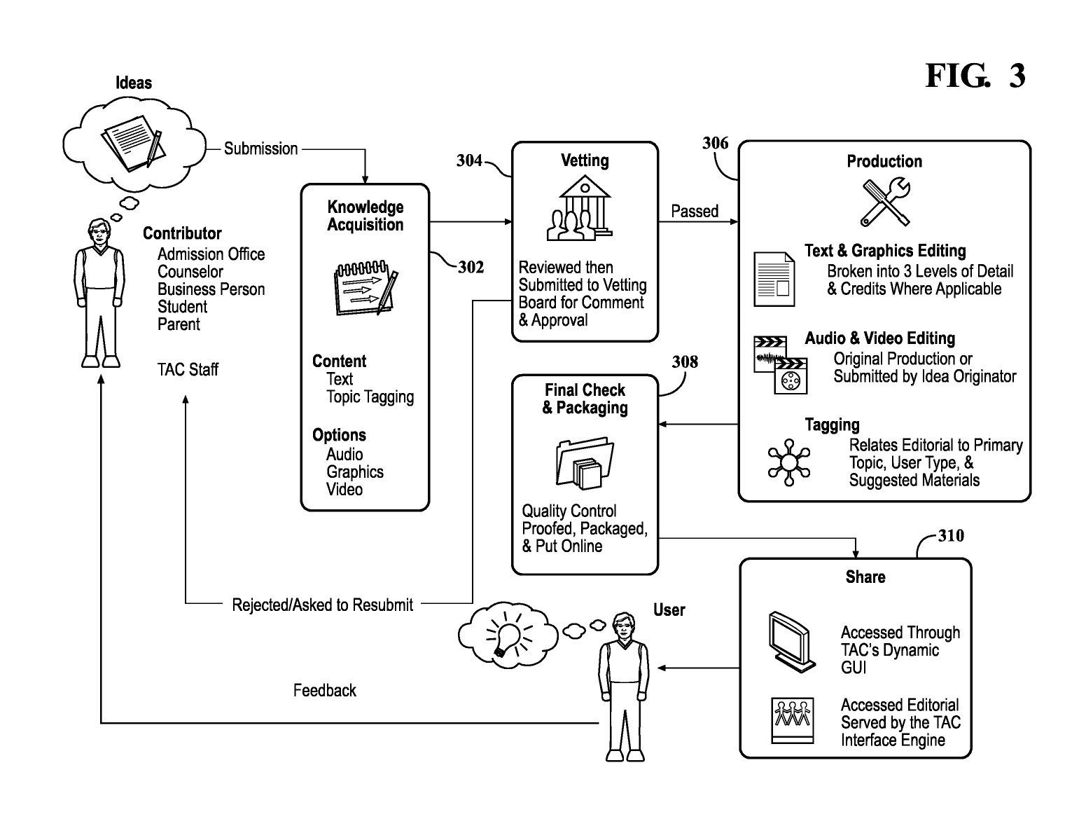

Vetting process 120 is a module, which vets editorial content submitted by users, prior to making the content available for matching by interface engine 104 and display upon dynamic GUI 100. Vetting process 120 may include content review for inappropriate subject matter, off topic subject matter, improperly tagged subject matter, and other editing. Vetting process 120 may include sending content to an external source (or a human source) for review and adjudication. An example method of vetting content, which may be used by vetting process 120, is described below with reference to FIG. 3.

Editorial contributor users may use system 10 to input data, such as counseling advice, institution information, and the like. Editorial contributors may be students, parents, counselors, high school administrators, teachers, coaches and/or directors. Editorial contributors may be sponsors, business professionals and other users. Editorial contributors may access system 10 via knowledge acquisition interface 122. Knowledge acquisition interface 122 may display system content inviting contributor users to suggest and share educational, editorial, or other content, and/or opinions they would like to see added to the academic counseling and other editorial content stored in long-term memory national editorial 114 and/or meta-knowledge rule base national 118. Content input by contributor users may be stored in long-term memory national editorial 114 and/or meta-knowledge rule base national 118. Input content is subject to vetting process 120.

As described with reference to dynamic GUI 100, knowledge acquisition interface 122 may be viewed by one or more user devices, such as a computing platform. For example, editorial contributors may use one or more user devices, such as a computing platform, to display and/or enter system data with knowledge acquisition interface 122. User device and computing platform capability, characteristics and components are as described above.

System 10 may also include activity monitor 124, which is capable of monitoring user activity with system 10. For example, activity monitor 124 may monitor system content viewed by users, duration of use of the content, order of use of system content, number of times of use for a particular piece of system content, and the like. Information from activity monitor 124 may be used in matching content to users by interface engine 104, categorizing content and/or in conjunction with data from meta-knowledge rule base national 118.

Activity monitor 124 communicates with report system 126, which is capable of generating various reports regarding system use. Report system 126 may generate other reports, such as sponsor reports regarding advertising, college reports regarding student trends, business reports regarding secondary market research reports, system reports for establishing new editorial, and/or other reports. For example, activity monitor 124 and reporting system 126 may be used to generate reports for a sponsor (to report on how well their ads are doing), colleges (to report on trends/provide secondary market research), and businesses (to generate secondary market research reports), as well as create reports which system 10 may use to create new editorial within system 10 (i.e., by tracking what is being used, what should be developed, dropped, etc.) and/or to develop marketing or other material to providing to various media outlets.

FIG. 2 is a diagram that shows possible uses and features of a college planning system 10. System 10 may have social networking and/or educational content providing capabilities. Social networking functionality may include market research 202, interactive editorial 204, data sharing 206 and/or topic forums 208. Educational content offerings may include sponsor ads 210, vetted editorial 212, tools and worksheets 214 and/or reviews and reports 216.

Market research 202 includes sponsor or other user provided market research information, such as surveys and the like and user responses to same, as discussed above with reference to market research 112 of FIG. 1.

Interactive editorial 204 provides school counselors the ability to localize material for students attending their school as discussed above with reference to long-term memory local school editorial 115 and meta-knowledge rule base local school 119 of FIG. 1.

Data sharing 206 represents the ability of students to share data with their high school counselor and others as well as colleges of their choice for posting their portfolios as discussed below with reference to tools and worksheets 214.

Topic forums 208 may include moderated forums 108 and/or feedback forums 110, discussed above with reference to FIG. 1. Topic forums 208 may be capable of receiving and/or displaying user input content. Topic forums 208 may include topics pre-set by system 10 and/or entered by various system users. Content may be vetted by system 10, as described with reference to vetting process 120 discussed above with reference to FIG. 1.

Sponsor ads 210 may include various forms and format of advertising provided by sponsor users that may be displayed by dynamic GUI 100 in various types of content and that may be stored in long-term memory national sponsor message 116 or in long-term memory local sponsor message 117, as discussed above with reference to FIG. 1. Sponsor ads 210 may be capable of storing and/or displaying one or more advertisements to users. Sponsor offers, promotions, and other data may be stored in sponsor ads 210. Sponsor ads 210 may include varied content in various singular and/or multi-media forms (text, images, video and the like), such as calendar items for displaying on a user's calendar, tools for the tool pallet, chat room displayed content, editorial content, and other content.

Vetted editorial 212 includes editorial content provided by system 10 or added by users that has gone through vetting process 120, as described with reference to FIG. 1 and/or FIG. 3 below. Data from student users, parent users, college admissions users, counselor users, sponsor users, business professional users and/or other users may be input to vetted editorial 212. Vetted editorial 212 may include counseling editorial, product and/or service reviews, report editorials and/or surveys, and other content. Editorial content may include content supplied by third parties and/or content provided by system 10, such as but not limited to, content derived from user supplied content and/or system use.

Tools and worksheets 214 may include productivity tools, worksheets, task tools, calculators, calendars, and other system content available for users to assist in the path to college. Tools and worksheets 214 may be organized into one or more modules or content pieces, based upon application to a particular editorial content topic, timeline, or action with regarding to the path to college. Tools and worksheets 214 may include calendar functionality that may allow for college admissions, counselor or other users to engage individual users by invitations to events (such as college nights, campus tours, college fairs, testing deadlines, and the like) and/or supplying deadline or date information for admissions.

Tools and worksheets 214 may also include a high school academic chronicle suite, which is designed for a student user. The high school academic chronicle suite may include a course planner, personal academic record (transcript and/or journal), portfolio/extra curricular journal and/or a posted portfolio posted and available for viewing by college admissions users. The course planner may provide suggested high school classes for a user to take, based upon personal admissions objective, course of planned study and other information from users and colleges. The high school academic chronicle may provide extracurricular or other activity information and suggestions to users. For example, it may suggest that a student complete community service, to raise chances of admissions success at university programs seeking candidates who are involved in community service activities. Counselors may be able to provide content, such as academic course recommendations, assignments, review progress, and communications to student and/or parent users via the course planner.

High school institutions may post information concerning course offerings, academic rigor, programs, athletics, school description information and other data for users, such as university admissions users. The personal academic record may allow student users to input grade information, and school and/or school grading system information, and may provide to students information concerning how colleges will weigh their grades and how the student may compare to other applicants. Colleges may input information regarding grade evaluation generally and/or specifically for a particular user.

The portfolio may allow for students to highlight awards and other accolade information to colleges for various academic and extracurricular activities. It may allow for audio, video, and/or photographic uploads to depict performance or showcase fine art portfolios, sports action accomplishments, and the like. It provides functionality for coaches, directors, high school administrators, teachers, personal references and others to input information concerning a particular student user. For example, if a student user identifies that she has participated in an athletic activity, the system may provide her a form to input vital statics or other information commonly considered by college coaches for that sport. For example, if a music student anticipates applying to conservatories, he may post audio and/or video clips of performances, auditions, compositions, and so forth. System tools may include other high school academic tools and/or worksheets.

Tools and worksheets 214 may include a college search suite, including personal college search criteria for a user, college crawler meta-search (an advanced customizable searching tool), college search worksheet capable of displaying search results, and/or a college visit checklist for displaying suggestions for a college visit (such as suggested questions to ask admissions professionals). For example, a feedback forum tool may be provided for campus visits with links to college evaluation forums. For example, a college visit checklist worksheet may be provided that organizes contact information, schedules, questions and other information concerning a planned university visit. Other college search tools and/or worksheets are possible.

Tools and worksheets 214 may include a financial planning suite, including by way of example, an expected family contribution calculator, budget worksheet having items of expenses to consider and/or a financial aid worksheet that may provide financial aid funding source information and/or clarification. The financial planning suite may include commonly asked questions regarding financial aid, such as federal aid forms, with answers. It may include tips for reducing college costs, information concerning funding sources and options, types of financial assistance and information concerning financial scams. The budget worksheet may gather current loan rates and terms information (federal, state, and/or private) and present a user with customized available sources based upon user personal profile information. Other financial planning tools and worksheets are possible within the scope and spirit of this application.

In various examples, tools and worksheets 214 may include a college fit suite, including a college fit worksheet, mock interview information, academic applications, financial aid applications, offer evaluation worksheet, and/or decision follow-through information and suggestions. The college fit suite may include side-by-side or other comparisons of colleges based upon personal college search criteria and ranked criteria weightings, information gathered in the college search suite, travel from home cost considerations, personalized budgeting for contemplated actual college costs based upon the user's personalized information, the campus visit checklist, information from the financial planning suite, and/or other sources. It may include an academic or financial aid application module that is capable of exporting personal profile information into one or more university admissions applications and/or financial aid applications. It may include information and deadlines calendared regarding early admission decisions, campus safety information and other information. The college fit suite may include information regarding conditional acceptance requirements, wait listing, need-blind acceptances, and/or advice if the applicant is denied admission. The college fit suite may include follow-through suggestions, such as thank you notes, acceptance letters, recommended or required acceptance steps (including actions that may be required by high schools, colleges, universities or others to complete high school, complete an admissions process, and/or accept financial aid), and/or letters informing colleges that the student has accepted admission elsewhere.

Tools and worksheets 214 may include a shopping and/or packing list having suggestions for what to take to college, college life, and/or other pre-orientation information. It may include a note pad allowing for user input comments and notes. It may include bookmarking and content sharing functions (for sharing bookmarked content pieces with other users), and/or emailing capabilities for sending system information, such as content pieces or links to system content, to others such as parents and/or friends. Tools and worksheets 214 may include a system help tool, and/or a glossary of terms including terms commonly used in college admissions.

Tools and worksheets 214 may include communication tools, such as forms, emails or contact forms, for allowing a user to provide editorial suggestions, comments, and/or contributions. In this manner, users may respond to system content and user supplied content, such as interactive editorial 204 and/or vetted editorial 212. Tools and worksheets 214 may include “letter to the editor” functionality to allow a user to send a system inquiry that may not be associated with particular content of vetted editorial 212. This information may be used by system 10 to build system content. Tools and worksheets 214 may also include instant messaging or chatting functionality for text, audio and/or video communications, and functionality for rating content, such as interactive editorial 204 and/or vetted editorial 212. Other tools and worksheets 214 are possible, and claimed subject matter is not intended to be limited to these particular examples or organization thereof.

Reviews and reports 216 may include in-depth reports on various topics central or secondary to a user's path to college journey. For example, an annual review and comparison of federal, state, and private loan programs may be a report. For example, a report of secondary school advanced placement courses and how they could reduce tuition costs may be provided. For example, a review and comparison of college entrance test-prep programs method of delivery, costs, and their effectiveness may be provided. Reviews and reports 216 may have an associated moderated user feedback topic forum 208 which may include the ability for users to rank various features regarding the topic (i.e. as in the experienced effectiveness of increasing an entrance exam's test score), as well as the ability to post comments of their own regarding the topic.

As FIG. 2 shows, colleges, institutions, universities, and admission professionals may use system 10. For example, colleges and admissions users may enter content into system 10 in vetted editorial 212. Colleges and admissions users may input and/or receive data from other individual users via data sharing 206. Colleges and/or admissions users may input and/or receive data from topic forums 208, such as one or more electronic forums for interactive electronic conversation on one or more topics regarding college admissions.

Counselor users, such as but not limited to, high school counselors or independent counselors, may input and/or receive data from interaction editorial 204. For example, a high school counselor user may input one or more counseling advice content pieces to editorial 204. Academic counseling content may include various content pieces aimed to guide a student or parent user through their personal timeline of steps on a path to college. It may differ based upon personal user information, such as the user's age, education level, time of year, etc. In this manner, system 10 may be capable of providing time relevant counseling content aimed to provide a more personalized and relevant experience and for focusing a user on time relevant tasks, by matching various content pieces to a user. In some examples, system 10 may include a widget for inputting data (without requiring a new web browser to launch). Counselor users may input and/or receive data from data sharing 206, which may provide a method to share data and guidance advice specifically pertaining to their school and/or counseling curriculum. Counselor users may input and/or receive data from topic forums 208. Counselor users may contribute to vetted editorial 212. Counselor users may input and/or receive data from tools and worksheets 214, which provides various tools and worksheets for users to use in acting upon various topics of content on the path to college.

In some examples, a feature of system 10 includes that information entered by counselors or teachers working at one given high school is specifically shared with users associated with and students that attend that high school. For example, a counselor can post the date and name of colleges coming to visit that high school. This calendar (and/or e-mail notification) will only be shared with students that attend that specific school and others associated with that school, i.e. parents and/or home schooled students within that district. For example, counselors may post information about a local scholarship program that pertains only to their school or local community. This information would not be presented to users across the nation. For example, counselors may post information about their schools academic rigor, specific programs, and other information college recruiters would find helpful in their evaluation of an applicant who graduated from that school. For example, a counselor may post several examples of effective essays, cover letters, or letters of reference for use by students and their supporters. In such cases, counselor posted information is school specific.

Sponsor users, such as but not limited to, advertisers, advertising agencies and the like may use system 10. For example, sponsors may input and/or receive data from sponsor ads 210. Sponsor users may input and/or receive data from market research 202, such as but not limited to, student user surveys and results. Sponsor users may input target advertising information, advertisement type and other ad categorization information to sponsor ads 210.

In some examples, local sponsors may select which students to reach by selecting the specific local high school they wish to support. Their ads would appear only to students attending those high schools (and home school students within a given zip code area). Regional and national sponsors have increasing levels of choices to select specific schools, groups of schools, zip code areas, marketing areas, states, or regions, in which they wish their ad to appear.

An individual user, such as but not limited to, a student or parent user, may use system 10. Some system examples place the individual user as a central focus of system functionality. An individual user may input and/or receive data from interactive editorial 204, such as information concerning their high school or local community. For example, the school's counselor may post information regarding college representatives that will be visiting the school, procedures and examples of letters of recommendation students may share with their references, information about local scholarships that students would likely overlook, and so forth. Individual users may input and/or receive data from data sharing 206, such as articles of interest, requests to write a letter of recommendation, request for feedback on specific topics, and so forth. Students may selectively post information through data sharing 206 to be viewed by colleges. The individual user may input and/or receive data from tools and worksheets 214, such as for filling out one or more electronic form worksheets such as financial aid planning worksheets, and admissions steps worksheets. Many further examples are possible.

The individual user may input and/or receive data from vetted editorial 212, which may include memory storing one or more user input content pieces that have been vetted by system 10 (or external to system 10) for appropriateness, tagging error, typographical errors and/or other errors.

The individual user may also input and/or receive data from sponsor ads 210 and/or market research 202, such as advertisements targeted to a particular individual user based upon that user's profile and/or system use history. For example, a sponsor may target market to high school juniors living in the Midwest, based upon personal profile information. Individual users may also input and/or receive data from topic forums 208, such as the advantages of joining a fraternity or sorority. Individual users may also input and/or receive data from other individual users, college admissions users, and/or counselor users in reviews and reports 216, such as rating the effectiveness of a test-pre course, commenting on experiences with advanced placement courses, satisfaction with various loan programs, and so forth.

This example of system 10 is designed to have the individual student or parent user be the central focus of system offerings and capabilities so they receive appropriately personalized and relevant information, editorial, advice, and other elements, rather than receiving “one-size-fits-all” generalized content. Other examples are possible. Other users may include business persons, such as users inputting information regarding a community or locality of a college. For example, a chamber of commerce may wish to input information concerning a town or city where a university is located. A weather service may wish to input weather information regarding geographic locations associated with institutions. In this manner, system 10 may include information to help a student user evaluate and make her own determination as to the right place to study, the right place to live and whether attending a particular institution would be a worthwhile investment, based upon the user's personal profile information and goals.

FIG. 3 is a flow diagram showing user input content vetting according to an example method of the present application. A contributor user, such as but not limited to, a college admissions user, high school counsel user, student, parent and/or business person, may input one or more submissions into system 10, as shown in knowledge acquisition block 302. Submissions may include text, or text and audio, graphics, video, or other forms of media and/or content. The contributor assigns one or more topic tags to the submission. In some system examples, a contributor may suggest one or more topical categories for tagging the submissions, a submission title, system content to which the submission relates, suggested audience and the like.

System 10 includes functionality for vetting the submission, as shown in block 304. For example, submissions containing profanity, inappropriate content (such as sexual, discriminating, violent or other offensive, illegal or objectionable content), or which is off-topic may be rejected. Content may be vetted at block 304 for typographical, grammatical, and/or other errors. At block 304, content may be compared to user assigned tags to determine whether a submission has been mis-tagged or whether the system determines that one or more other tags should be connected to the submission. As shown in FIG. 3, submissions may be rejected and optionally a message may be sent to the contributor regarding the content rejection and/or requesting resubmission. Content vetting may also include review by an editor or other user or person external to system 10. Some examples of system 10 may include at block 304 communication generation functionality for notifying external vetting sources of a submission available for review and/or sending the content to the external vetting expert.

Once content of a submission is approved, the submission may be put into production, as shown at block 306. Production may include text, graphics, audio, and/or video editing and content tagging. For example, editing may include breaking the contributed material into three levels of editorial detail within its group title. The three levels of editorial detail may include subject (an introductory overview of the content's area of focus), topic (more detailed outline that details each are discussed), and the editorial article itself (providing detailed discussion providing succinct points to be made about each topic). Editing may also include adding credits, which provide recognition of the contributing author, their job title, institution or company for which they work, years of experience, and other possible factors relevant to their contribution. Editing may include audio and/or video editing, such as requesting the contributor of a text-based contribution to submit or participate in an audio and/or video recording (or creating an audio and/or video using another participant) that needs to be edited to the proper technical formatting for system 10. Editing may include tagging content to relate editorial to one or more primary topics, user types, and/or suggested materials, such as those discussed regarding block 304.

Edited content may be quality control checked (text proofed for grammar and typos, audio and video proofed for continuity, framing, clarity, and so forth) and/or require further packaging (be put into the correct file format and/or compression package), as shown at block 308, required to put the content online within system 10.

Packaged content may be shared, as shown at block 310. It may be viewed via the dynamic GUI 100 and/or knowledge acquisition interface 122 as described above with reference to FIG. 1, available for matching to users, stored in the editorial content database, and/or available in the knowledge acquisition database for other users to use in providing further content (which they may tag as relating to it) at block 302. The interface engine may send editorial content to specific users based upon user profiles, user system use and/or rules and filtering. Users may provide feedback to contributors regarding content, such as via one or more feedback forums.

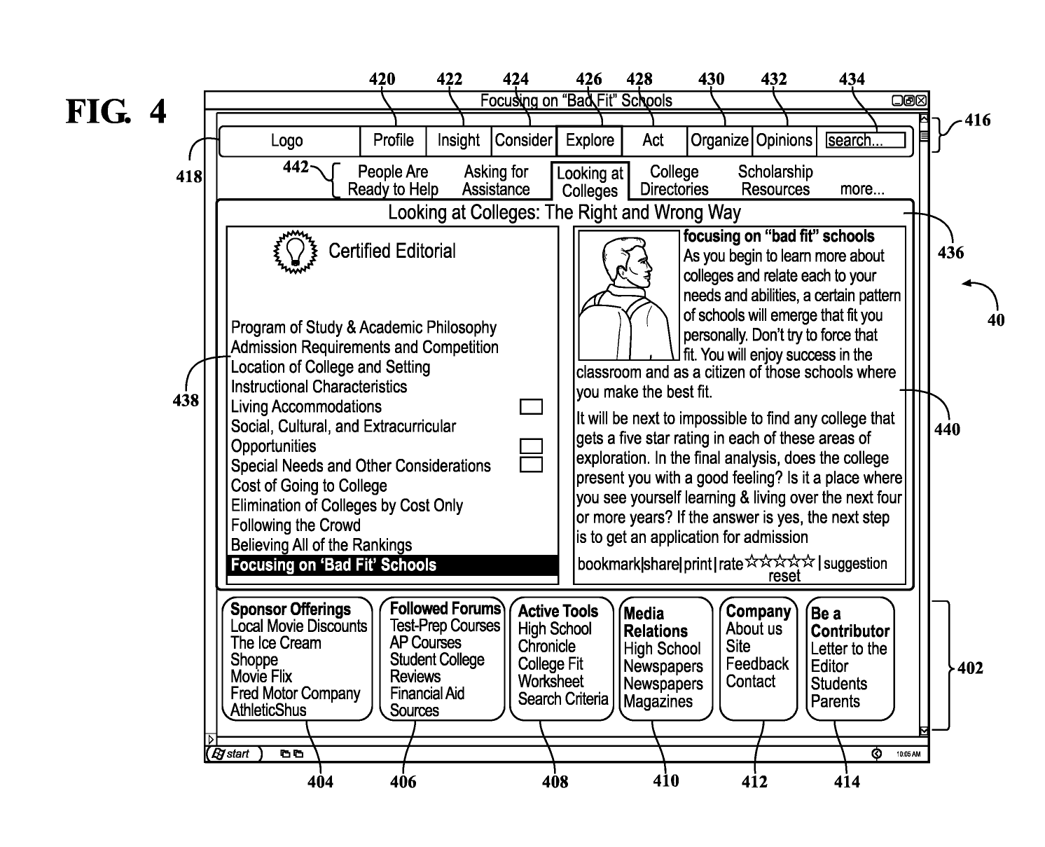

Referring now to FIG. 4, an example graphical user interface 40 for the system is shown. It may be viewed via the dynamic GUI 100 and/or knowledge acquisition interface 122, as tangibly embodied in a user device, such as a computing platform, as described above with reference to FIG. 1. It may include a customizable tool pallet 402 capable of displaying various tools, and act as a tool navigator. Tool pallet 402 may include graphic user interface tools for system functionality such as rating, saving, organizing, bookmarking and/or recalling system content. Tool pallet 402 may include sponsor offerings 404, which may be customized for a particular user to display the promotions and advertisements available for that particular user. Content from long-term memory national sponsor message 116 or in long-term memory local sponsor message 117 may be matched to a user with rules from meta-knowledge rule base 118 (FIG. 1) based upon data from personal profile 106 (FIG. 1) and/or system use. Tool pallet 402 may include followed forums 406, which may display the forums that the particular user is following, as determined by user selection. Tool pallet 402 may include active tools 408, which may display the one or more tools and/or worksheets 214 (FIG. 2) that the particular user has selected for use. Tool pallet 402 may include media relations 410, which may display resources for various media to use as well as press releases and media reports on system 10 itself. Tool pallet 402 may include company 412, which may display identifying data concerning system 10. Tool pallet 402 may include “Be a contributor” 414, which may provide one or more links for a user to click to access functionality for contributing editorial content to system 10. Tool pallet 402 may contain various other fields such as breaking news relating to issues related to planning for college (academic, social, and financial), additional resources which operate outside of system 10 (counseling services, financial services, sports regulatory bodies, and so forth), and the particular fields displayed may vary user to user, and/or for a particular user at various points in time.

Graphical user interface 40 may include functionality for displaying editorial content in a categorized manner for customized display to users, such as via category bar 416 (editorial functional group heading). Category bar 416 includes a home button 418 capable of being selected by a user to return to the home page of the system. In this particular example, category bar 416 shows editorial content categorized and/or displayed as profile content 420, insight content 422, consider content 424, explore content 426, act content 428, organize content 430, and opinions content 432. Category bar 416 also includes a search field 434 capable of accepting user input terms for searching the system.

Profile content 420 may include various items of personal profile information, current goal expectations, information control settings, reminders, and various other user selected settings as discussed in personal profile 106 in discussion of FIG. 1.

Insight content 422 may include background information and considerations for users regarding why go to college, colleges, college selection and the admissions process. It may provide educational content. For example, it may examine myths related to college planning, exploration, application, financing, and so forth that are perpetuated by common lore and inadequate media reporting. For example, it may discuss trends in the college admission process such as adopting or dropping need-blind admission policies or changes in commonly used test programs. For a career planning example, it may provide information about careers of interest to the user, such as typical pay, typical job tasks and responsibilities, typical job locations, training and education needed to achieve the targeted job.

Consider content 424 may include content aimed to raise issues, provide educational content and give student or other users “food for thought,” to highlight considerations that the user may not otherwise contemplate. Based upon one or more rules from meta-knowledge rule base national 118, interface engine 104 may identify content for the “consider” category for a particular user based upon information from personal profile 106 for that user and system use information from activity monitor 124 (FIG. 1). Consider content 424 may build user awareness of admissions considerations, including considerations that the user may not have thought of on his own. Consider content 424 may build user awareness of career degree requirements and relate those to particular classes needed to reach the degree, and include considerations that the user may not have thought of on his own. Content categorized as consider 424 may vary user to user, and may be categorized as another type of content user to user. For example, content regarding travel expense consideration for a southwestern student user interested in attending a school in Florida may appear as consider content for that user, but may not be categorized as consider content for a student user from Michigan seeking to attend college in Michigan. Content for a career planning user may include course requirements for obtaining a degree needed for a desired career.

Explore content 426 may include suggestions and resources for how to examine and research various topics, such as but not limited to, college directories and scholarship resources, career directories, employer directories, and the like. Explore content 426 may provide suggestions for the user to gain knowledge about college programs, university life and other topics, that he may be evaluating or researching. For example, the user may be exploring whether she likes big universities or small colleges. Explore content 426 may provide suggestions for how to research this topic and information sources. Explore content 426 may be provided by the system based upon personal profile 106 data and/or user system use information from activity monitor 124, and interface engine 104 may identify content for an “explore” category based upon one or more rules of meta-knowledge rule base 118 (FIG. 1).

As shown in FIG. 4, explore content 426 is highlighted for content regarding “Looking at Colleges: The Right and Wrong Way,” which appears in content title bar 436. The displayed explore 426 content includes a listing of vetted topic editorial content in field 438 for this particular content module. In this example, the last topic listed “Focusing on ‘Bad Fit’ Schools” is selected. Field 440 displays text (which may include audio and/or video) for a particular topic listing, as selected by a user for display in field 440. In this example, it includes the content text and an image for the “Focusing on ‘Bad Fit’ Schools” topic selection.

Act content 428 in category bar 416 is also user specific. Act content 428 may present tools and/or connections to accomplish tasks needed and/or recommended to move forward with decision-making and/or admissions steps. Act content 428 may include tools and worksheets 214 (FIG. 2), such as a college fit worksheet, budget worksheet and others discussed above.

By way of example regarding a method of using categorized content with the present system, consider content 424 may display a location question regarding what type of geographic community a student desires for college—urban or rural? Explore content 426 may display content that suggests informally visiting colleges to see what the settings are like. Based upon this information, the system may provide “re-consider” functionality, and return to consider content 424 to pose follow-up questions to the user (i.e. urban is too busy, rural is too remote, what is in between?). The system may provide “explore further” functionality, and return to explore content 426 to display content regarding recommendations to visit smaller city settings, less rural settings or fringe urban settings. The system may then provide consider content 424 to allow a user to firm up preferences of location type. The system may provide act content 428, such as recommendations to suggest that a user schedule a formal campus visit/tour through admissions officers. As exemplified, content displayed may jump between categories and display to a user need not progress from category to category in a particular order of use.

Other categories for organizing editorial content are possible. The “consider,” “explore,” and “act” and other classifications are merely examples of many possible manner with which editorial content may by filtered, categorized and/or displayed with the system.

Organize content 430 in category bar 416 is also user specific. Organize content 430 may present tools and/or connections that assist the user in keeping data and materials organized, referenced, and connected. For example, the calendar allows users to make their own entries of appointments and/or deadlines, as well as view those that they can subscribe to through settings in their personal profile 106 that may be universally included, or may be associated with the high school they attend. For example, users may establish connections with others using system 10 and establish what information they wish to share or withhold from each. For example, users may make notes and view material they choose to bookmark while using system 10. Other organizational tools are anticipated.

Opinions content 432 may include counseling advice, advisor opinions, peer opinions, alumni opinions, student opinions and the like.

Many other examples are possible and content categorization may be based upon content tagging as part of the vetting process, rules from meta-knowledge rule base national 118, data from user personal profile 106, and/or information from activity monitor 124. System content may be filtered, categorized, characterized, displayed and/or provided to various users in a customized manner.

FIG. 4 also shows subject bar 442, which may include suggested resources for further help and/or information. Subject bar 442 may include a “People are ready to Help” button which includes editorial detailing how individuals other than those in traditional roles of high school counseling or college admission can assist in the path to college process. For example, coaches can help with aspects of obtaining athletic scholarships and meeting requirements of overseeing athletic organizational bodies (e.g. NCAA). For example, music and performance directors can provide insight into how to prepare for auditions. For example, business professionals can provide guidance as to trends within an industry and programs that are possibly suited to pursue them. Subject bar 442 may include an “Asking for Assistance” button, which provides examples of how to approach various individuals when seeking their help.

Subject bar 442 may include a “Looking at Colleges” button for accessing information concerning the various attributes a user may consider when examining colleges, methods that may be helpful, methods to avoid because they may provide misleading results, various approaches that may benefit the user, as well as other material and data. Subject bar 442 may have a “College Directories” button, which may be selected to access a directory of colleges for which information is available within the system. Such information may be provided by college representatives as editorial content, or imported into the system from one or more external sources.

Subject bar 442 may include a “Scholarship Resources” button which may be selecting to access information concerning scholarships that may be available to a user, customized for a user based upon personal profile and/or system use data. Subject bar 442 may include other fields for accessing other topics of information and this is merely one possible example. Subject bar 442 may vary in content from category to category, 420-432 in FIG. 4.

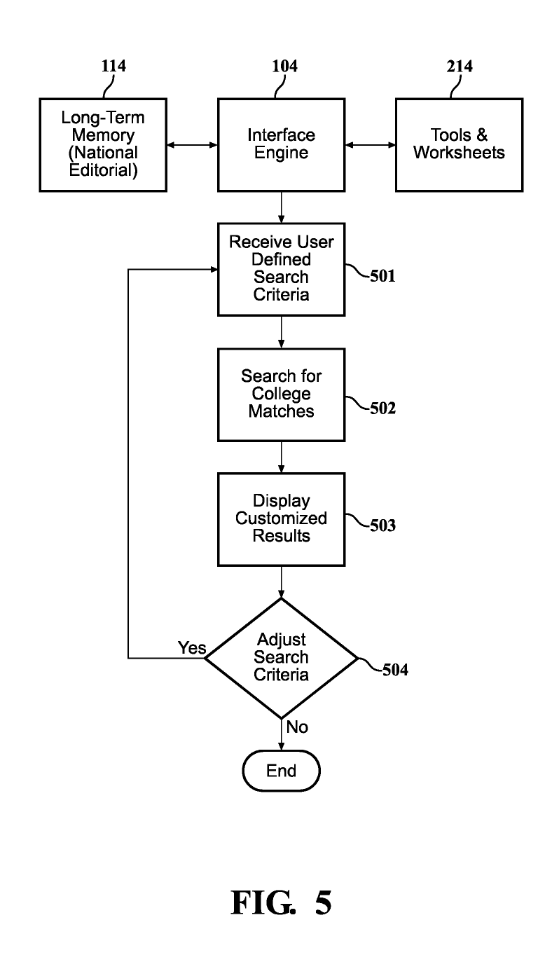

As shown in FIG. 5, the present application provides a method for college searching and matching functionality for students to find potential college matches. While this method is displayed in a college planning context, it also may be used for a career planning example. This method may be performed by interface engine 104, using data from tools and worksheets 214 and/or long-term memory 114 and/or 115. Block 501 depicts that the system is capable of receiving user defined search criteria for searching for one or more colleges or jobs. Search criteria may include user selection of search criteria listed or suggested by the system and/or user input search terms. For example, a user could select a geographical area of preference from a category listed by the system, such as “Virginia” and an institution size/type suggested by the system as “Medium or Large Sized Universities.” The user could also provide text based terms including: “I like the mountains. I want to be able to river raft near school.” The user could provide text based terms “I want to be an astronaut. What college degree do I need to become an astronaut? Which schools have the best degree programs for becoming an astronaut, and which courses do I need to take?” Many other examples are possible and this example is merely provided for illustrative purposes.

Block 502 shows that the system may search for colleges or jobs. The system may apply the user input search terms and search with interface engine 104 the college directory database information, which may be located in long-term memory 114, for schools having the attributes selected by the user.

Block 503 portrays that the customized results are displayed for user review. Results may be displayed on dynamic GUI 100. For example, the search may provide Virginia Polytechnic Institute and State University as a result, Virginia Military Institute as a second result, and the University of Richmond as a third result.

Adjustments may be made to searching criteria based upon review of search results, as shown at diamond 504. For example, the user may not wish to attend a college in Richmond, Va. and may decide to further define search criteria to add in this qualification.

If adjustments are made, then the method returns to block 501 to receive further defined search criteria. In this particular example, the user may add a term in text “not in Richmond, Va.” The system would then perform a new search and produce results at block 503. With this revision, the Richmond based schools would not be in the search results, nor displayed at block 503.

Each function, blocks 501-503 and/or diamond 504, may have associated tools and/or worksheets provided by the system, stored in tools and worksheets 214. This method may be accomplished by interface engine 104, as described with respect to FIG. 1.

For example, system functionality for defining search criteria may include providing a user a worksheet from tools and worksheets 214, described with respect to FIG. 2, to assist with criteria suggestions and categories for the user to consider. Criteria may include information regarding, for example, university programs, geographic location, the community, sports programs, scholarship opportunities, institution size, student organizations, Greek life, and other information. In a career planning context, system could include criteria such as salary, bonuses, benefits, workplace atmosphere, geographic location, performance review regularity and process, project team, potential for advancement, travel, and others. These examples are illustrative and not intending to be limiting, as users may set their own criteria for searching for matching colleges. System functionality for defining search criteria allows for user input criteria, rather than restricting users to pre-set criteria. For example a user could search for colleges located in the northeast, having strong English departments and a NCAA Level 1 soccer program.

System 10 also allows for ranked weighting of user perceived importance of criteria. For example, a user could search for colleges based upon user input criteria of having a coffee shop within walking distance of campus, but then have the ability to assign a ranking to that criteria as to how important that factor is in selecting a college. In that instance, maybe whether a college has a desired degree program is ranked higher in importance by that user than its proximity to a coffee shop. For a career planning example, system 10 also for ranked weighting of user perceived importance of criteria, such that a user could rank salary higher than whether the offer includes a free dry cleaning service as a benefit.

System 10 may include an Internet based or other communications portal, which may be used to gather college information directly from college websites, third party sources and/or college supplied information provided to system 10 by university representatives, for storing in long-term memory national editorial 114. In this manner, the search may include current information regarding the institutions gathered during the search itself, rather than solely relying upon university representatives to update profile information provided to the system. Similarly, for a career planning system example, data may be gathered by system 10 directly from various companies regarding job openings, qualifications, job locations, etc.

Display results, as shown in block 503, may include displaying for the user calendar information for an institution. For example, college night information for a university appearing in search results may be added to a user's calendar in their toolbox as defined in toolbox 111, as described above with reference to FIG. 1, and tools and worksheets 214, as described above with reference to FIG. 2. Similarly, for a career planning example, calendaring information may include on-campus interviewing, off-campus interviewing, acceptance timing/deadlines, etc. Search results may be saved and manipulated, such as by annotation by a user to memorialize notes.

The system also includes methods and functionality for assisting a student or parent to evaluate admissions offerings. Tools and worksheets 214 may be used for the offer evaluation functionality, as described above with reference to FIG. 2. Offer evaluation may include various factors of the institutions academic offerings such as rigor (for example, last year's average GPA and test scores for the entering freshman class), strength of faculty credentials, instructor/student ratios, facilities and so forth; social considerations such as student body demographics, student body size, geographic setting, travel to college mode and distance, and so forth; and financial considerations of costs related to comprehensive fees, scholarship/grant/work-study offerings and terms, travel costs, and so forth. Tools and worksheets 214 and may be used to evaluate job offerings. Job offer evaluation functionality may be used for a career planning example of the present system, using salary, benefits, job scope, geographic location, quality of life in that geographic location (schools, museums, art and culture, city size, sporting events, parks, and the like) company type, project area of study, potential for promotions, etc.). Many other examples exist.

As described above, one or more user devices, such as a computing platform may be used with system 10 to tangibly embody one or more methods, processes, functions, features as descried with reference to FIGS. 1-5 above. However, such a user device or computing platform may include more and/or fewer components than those described above. Structure described is merely one example of a possible physical structure tangibly embodying one or more processes, methods, functions or features of system 10. Generally conventional components may not have been shown, for example, a battery, a bus, and so on.

The computing platform may be utilized to embody tangibly a computer program and/or graphical user interface by providing hardware components on which the computer program and/or graphical user interface may be executed. The computing platform may be utilized to embody tangibly all or a portion of FIGS. 1-5 and/or other procedures disclosed herein. Such a procedure, computer program and/or machine readable instructions may be stored tangibly on a computer and/or machine readable storage medium such as a compact disk (CD), digital versatile disk (DVD), flash memory device, hard disk drive (HDD), cloud memory and so on. Claimed subject matter is not limited in this regard.

It will, of course, be understood that, although particular examples have just been described, the claimed subject matter is not limited in scope to a particular example or implementation. For example, one example may be in hardware, such as implemented to operate on a device or combination of devices, for example, and another example may be in software. Likewise, an example may be implemented in firmware, or as any combination of hardware, software, and/or firmware. Another example may comprise one or more articles, such as a storage medium or storage media such as one or more SD cards and/or networked disks, which may have stored thereon instructions that if executed by a system, such as a computer system, computing platform, or other system, may result in the system performing methods and/or displaying a user interface in accordance with claimed subject matter.

In the preceding description, various aspects of claimed subject matter have been described. For purposes of explanation, specific examples, numbers, systems, platforms and/or configurations were set forth to provide an understanding of claimed subject matter. To the extent that computer file types and languages, and operating system examples have been used, it has been for purposes of illustrating a particular example. However, it should be apparent to one skilled in the art having the benefit of this disclosure that claimed subject matter may be practiced with many other computer languages, operating systems, file types, structures, computing platforms and components, user interfaces for system 10, and without these specific details, displays and system architecture. In other instances, features that would be understood by one of ordinary skill were omitted or simplified so as not to obscure claimed subject matter. While certain features have been illustrated or described herein, many modifications, substitutions, changes or equivalents will now occur to those skilled in the art, particularly with reference to the specific computing platform example, specific system architecture and specific user interface displays described herein. The present system, article and method may be tangibly embodied with other computing platforms and future developments thereto. It is, therefore, to be understood that claims are intended to cover all such modifications or changes as fall within the true spirit of claimed subject matter.

I claim:

1. A computer-implemented post-secondary education or career planning system comprising:
a dynamic graphical user interface configured for displaying student data and post-secondary education institution data or career data upon a display of a computing platform;
an interface engine having a processor configured for computing the post-secondary education institution data and college editorial data or career data, and career editorial data to display on the dynamic graphical user interface and configured for receiving the student data input from one or more users, the student data comprising text, audio, video or multimedia based content;
a user database comprising memory adapted for storing personal profile data for the one or more users that is received by the interface engine from the dynamic graphic user interface, the personal profile data selected from the group consisting essentially of user profile data, user system use data, and one or more user forum entries;
a student database comprising memory adapted for storing the student data, the student data comprising demographic and survey obtained information about one or more student users, the student data further comprising data from the group consisting essentially of grades, test scores, athletics, accomplishments, activities and geographic region, the system configured to receive student data from one or more student users and/or third party input data, the third party input data selected from the group consisting essentially of parent input data, teacher input data, counselor input data, coach input data, administrator input data and director input data;
a post-secondary education institution database comprising memory adapted for storing the post-secondary education institution data, the post-secondary education institution data selected from the group consisting essentially of university programs, scholarships, athletics, campus life, admissions criteria, admissions considerations, admissions processes, admissions deadlines, financial aid information, financial aid deadlines and geographic area;
a career database comprising memory adapted for storing the career data, the career data selected from the group consisting essentially of salary, benefits, job scope, geographic location, quality of life in that geographic location, local schools, local museums, local art and culture, city size, sporting events, parks, company type, project area of study, potential for promotions, bonuses, workplace atmosphere, performance review regularity and process, project team, potential for advancement and travel;
the system is configured to receive the post-secondary education institution data and the career data by the interface engine from one or more post-secondary education institutions and/or from one or more third party sources;
one or more meta-knowledge rules bases comprising memory adapted for storing one or more rules for matching one or more of the post-secondary institution data to one or more of the student data and one or more rules for matching one or more of the career data to one or more of the student data, the meta-knowledge rules bases further comprising one or more rules for displaying the post-secondary educational institution data and career upon the dynamic graphical user interface, and one or more rules for displaying the student data upon the dynamic graphical user interface;
the processor of the interface engine configured for matching one or more post-secondary education institution data to one or more student data based upon one or more rules stored in the meta-knowledge rules bases and based upon user generated and input search terms and not user selection of pre-set search terms;
the processor of the interface engine configured for matching one or more career data to one or more student data based upon one or more rules stored in the meta-knowledge rules bases and based upon user generated and input search terms and not user selection of pre-set search terms;
the processor of the interface engine configured for displaying the post-secondary education institution data and the career data, and/or the student data based upon one or more rules stored in the meta-knowledge rules bases and the student data;
a marketing database configured for storing messaging data from one or more sponsor users, sponsor advertisements or promotions, the meta-knowledge rules base further comprising targeting functionality configured for matching the sponsor data to one or more users based upon the user profile data and/or the user system use data, the processor of the interface engine configured for matching the sponsor content in the marketing database to the one or more users, the matched sponsor content being viewable to one or more targeted users on the dynamic graphical user interface;
a knowledge acquisition interface configured for receiving editorial content from one or more contributor users providing advice to student users regarding post-secondary education institution options or career options, the editorial content is stored in memory and is selected from the group consisting essentially of post-secondary education institution information, career information, advice, educational content, counseling information, local school data, national school data, and counseling data;
the knowledge acquisition interface further comprising tagging functionality that is configured to allow the contributor users to assign one or more topical tags to the editorial content, the system is configured to search the editorial content by the topical tags;
the meta-knowledge rules base further comprising one or more matching rules for matching editorial content to one or more users for display upon the dynamic graphical user interface based upon the tagging of the editorial content and the user profile data and/or user system use data;
the meta-knowledge rules bases further comprising student directed matching functionality configured to match the student user to editorial content and/or to one or more post-secondary education institutions or careers based upon student user defined matching criteria, the student user defined matching criteria is not selected from a pre-set system list of criteria, the student user directed matching functionality comprises one or more customizable filters provided by the student user, the system is configured for searching the editorial content and/or post-secondary education institution database and/or career database based upon the customizable filters provided by the student user rather than provide ranked matches based solely upon system set criteria;
one or more moderated forums configured for receiving the user forum entries and data regarding post-secondary institution education topics that are topically organized based upon one or more rules of the meta-knowledge rules base and stored in a memory as moderated forum data; the one or more moderated forums comprising at least in part one or more social networking forums for communication between users;
one or more feedback forums configured for receiving the user forum entries and data regarding editorial content that is topically organized based upon one or more rules of the meta-knowledge rules base and stored in the memory as feedback forum data;
a toolbox configured for display upon the dynamic graphical user interface comprising one or more tools or worksheets for users to select in acting upon system recommended tasks for college or career planning, the system recommended tasks are generated by the processor of the interface engine based at least in part upon one or more rules of the meta-knowledge rules bases and the student data; and
a calendar configured for calendaring college planning dates and deadlines selected from the group consisting essentially of admissions deadline data, college visit data, college nights or other admissions related events, entrance exam testing deadlines, financial aid deadlines, early admission deadlines, and/or other dates based at least in part upon one or more rules of the meta-knowledge rules bases, or career planning dates and deadlines selected from the group consisting essentially of on-campus interviewing data, off-campus interviewing data, acceptance timing and deadlines data, the calendar is configured for display on the dynamic graphical user interface, the calendar is customizable for a particular user, and is adapted to accept multi-media input from multiple sources, including universities, counselors, students, parents, employers and others.

2. The system of claim 1, the meta-knowledge rules base further comprising privacy settings configured to allow a user to elect what information from the user's user profile in the user database may be viewed by other users, the privacy settings are configured to allow for different information to be shared with different users, different types of third party users and/or customized on a case-by-case basis by providing information only to selected friends, counselors, teachers, mentors, and/or one or more specific institutions that the user selects.

3. The system of claim 1, the tools or worksheets selected from the group consisting essentially of: a student planner, a course planner, a personal academic record, a posted portfolio, a student profile published for institution viewing, a personal college search criteria document, a college search worksheet configured for users to organize and display search results, a college visit checklist, a budget work sheet, a financial aid worksheet, a college fit worksheet, one or more post-secondary institution application materials, an offer evaluation worksheet configured for comparing post-secondary admission offers, and a packing list for what to take to school.

4. The system of claim 1 further comprising admissions preparation components selected from the group consisting essentially of a mock admissions interview to prepare a student for the admissions process, decision follow through functionality including recommended actions to take to follow up on applications and/or acceptances, thank you notes, declination letters and/or acceptance letters for students and/or families to send to one or more of the post-secondary education institutions via the system.

5. A computer-implemented college and career planning system comprising:
a dynamic graphical user interface configured for displaying upon a display of a computing platform, the dynamic graphical user interface comprising a portal with which users may access the college and career planning system, the dynamic graphical user interface configured for displaying user specific content and configured for being customized for a particular user based upon user personal profile data for that user and/or user system use data, the dynamic graphical user interface further comprising template content for a student user and/or template content for a parent user, the student user template content differs from the parent user template content;
a short-term memory configured for being accessed by the dynamic graphical user interface for preparing and/or displaying the user specific content for the dynamic graphical user interface;
an interface engine configured for engaging related databases of the system and retrieving post-secondary education institution materials and career materials from a long-term memory for presentation upon the dynamic graphical user interface, the interface engine further comprising a web server configured for web based communications with one or more remote databases;
one or more meta-knowledge rule bases configured for storing one or more rules for filtering system data for display for a user, the interface engine configured for engaging the related databases of the system and retrieving the post-secondary education institution materials and the career materials from the long-term memory for presentation upon the dynamic graphical user interface based at least in part upon user generated and input selections and not based upon user selection of pre-determined search terms, the interface engine comprising one or more processors configured for matching content with a user based upon the one or more rules from the one or more meta-knowledge rule bases and computing one or more displays for the dynamic graphical user interface based at least in part upon one or more of the meta-knowledge rules and the user profile data and/or the user system use data;
a personal profile database configured for storing the user personal profile data and the user system use data and configured for being engaged by the interface engine;
one or more long-term memory editorial databases configured for receiving editorial content from contributor users and storing editorial content, the long-term memory editorial databases comprising national editorial and local editorial, the national editorial content configured for being viewed by any user and the local editorial content configured for being matched to one or more users based upon one or more schools affiliated with the user and displayed only to the matched users;
one or more moderated forums configured for user-to-user communications, the interface engine configured for interfacing with the moderated forums, the moderated forums configured for receiving user input content comprising an interactive exchange of posts or messaging content, the moderated forums configured for organizing content by topic;
one or more feedback forums configured for providing feedback regarding one or more of the editorial content, the interface engine configured for interfacing with the feedback forums, the feedback forums configured for organizing content by one or more editorial content topics, the editorial topics evolving based upon system use;
a toolbox comprising one or more worksheets, the interface engine configured for interfacing with the toolbox, the worksheets configured for accepting user input data regarding planning for post-secondary education or careers; and
a vetting module configured for vetting the editorial content prior to making the editorial content available for matching by the interface engine and available for display upon the dynamic graphical user interface, the vetting module vetting the editorial content by reviewing for inappropriate subject matter, off topic subject matter, or improperly tagged subject matter based upon one or more rules of the meta-knowledge rule base.

6. The system of claim 5 further comprising an activity monitor configured for monitoring user activity with system by monitoring system content viewed by a user, duration of use of the content, order of use of system content, and/or number of times of use for a particular piece of system content; data from activity monitor is used at least in part for matching editorial content to users by the interface engine with data from meta-knowledge rule base, and for categorizing editorial content into the topics of the moderated forums.

7. The system of claim 5, further comprising one or more long-term memory sponsor messages configured for storing sponsor message content, the long-term memory sponsor messages comprising national sponsor messages and local sponsor messages, the national sponsor messages configured for being viewed by any user and the local sponsor messages configured for being matched to users based upon user profile data and/or user system use data and displayed only to the matched users.

8. The system of claim 5, the user personal profile data comprising one or more data from the group consisting essentially of user identification data, name, address, user type, demographic information, user educational information, current school of attendance, grade level, entrance exam test score information, financial information, student expectations, abilities, student college/degree program goals, planned course of study, student/work scheduling, desired attributes of a post-secondary program, college preference information, activities, professional information, professional experience, high school identifying information college identifying information, financial institution identifying information, parent demographic information, sponsor information, user system use goal information, user selections regarding privacy, user restrictions upon use or display of personal profile information, information regarding calendaring options, one or more user selections of calendaring options, data provided by the system, and marketing research or surveys that the user selects for participation; and
the personal profile database configured for receiving the user personal profile data from one or more electronic surveys and/or forms, and/or imported into the system from one or more external sources.

9. The system of claim 5, the feedback forums selected from the group consisting essentially of campus tour feedback, student or alumni evaluation of colleges, financial aid feedback, financial scam feedback, advanced placement course feedback, college admission policy feedback, employer on-campus interview feedback, employer off-campus interview feedback, and alumni employed by a target employer feedback.

10. The system of claim 5, the editorial piece feedback comprising user opinion content for one or more particular subjects, one or more user ratings for specific subjects, one or more user ratings for a reviewed product or service, and rating criteria supplied by the system.

11. The system of claim 5, the toolbox further comprising an academic chronicle series of worksheets that build on each other for planning high school courses and tracking high school grades,

12. The system of claim 5, the toolbox further comprising a selection criteria worksheet configured for receiving one or more student user input college search terms or career search terms and a student assigned importance level to the college or career search terms, the system configured for searching for matching post-secondary education institutions and employers based upon the student user input search terms and assigned importance level.

13. The system of claim 5, the toolbox further comprising one or more budget and financial aid worksheets providing a modifiable outline of budgeting considerations and fields that aggregate and project expected expenses.

14. The system of claim 5, the toolbox further comprising high school academic chronicle suite comprising a course planner, a personal academic record, a portfolio/extra curricular journal, and/or a posted portfolio posted and available for viewing by one or more college admissions users, the course planner providing suggested high school classes for a student user to take based at least in part upon the student user's course of planned study, the high school academic chronicle may provide extracurricular or other activity suggestions to a student user, and the high school academic chronicle may be accessed by a counselor user for providing academic course recommendations, assignments, reviewing progress, and sending communications to student users and/or parent users via the course planner.

15. The system of claim 5, the toolbox further comprising a college fit suite comprising one or more tools selected from the group essentially consisting of a college fit worksheet, mock interview information, one or more academic applications, an academic or financial aid application module that is configured to export user personal profile information from the system to one or more university admissions applications and/or financial aid applications, one or more financial aid applications, calendared deadlines regarding early admission decisions, an offer evaluation worksheet, a campus visit checklist, conditional acceptance requirement data, wait listing data, need-blind acceptance data, admission denied data, follow-through suggestions, thank you notes, acceptance letters, recommended or required acceptance steps, letters informing colleges that the student has accepted admission elsewhere, and a side-by-side comparison of two or more colleges based upon personal college search criteria and ranked criteria weightings, the personal college search criteria comprising one or more criteria selected from the group essentially consisting of information gathered by the student user in the college search suite, travel from home cost considerations, personalized budgeting for contemplated actual college costs based upon the user's personalized information.

16. The system of claim 5, the editorial content selected from the group consisting essentially of academic based content, career based content, university information, employer information, educational content, admissions related topics, counseling content and calendaring content capable of being personalized for a user to announce admissions deadline information, recommended steps on the path to college, event information, job placement information, job qualification information, calendared content for application deadline information, and on-campus interview dates,

17. The system of claim 5, the meta-knowledge rule base comprising one or more rules for filtering matches between system users and editorial content based upon user profile data and user system use data, the meta-knowledge rules comprising university determined criteria for content matching editorial content to students meeting university admissions criteria.

18. The system of claim 5, the meta-knowledge rule base comprising one or more rules for filtering matches between system users and editorial content based at least in part upon criteria selected from the group consisting essentially of student grade level, user type and school of attendance.

19. The system of claim 5, the local editorial content received by the system from a local school teacher, administrator, counselor or other user associated with the local school.

20. A dynamic graphical user interface for display upon the display of a computing platform comprising:
a personal profile display comprising user personal profile data and user system use data;
a customizable tool pallet for a computer-implemented college or career planning system configured for displaying on the display of a computing platform, the tool pallet comprising a tool navigator for selecting one or more tools for accessing functionality of a college or career planning system for rating, saving, organizing, bookmarking and/or recalling system content;
the tool pallet further comprising one or more tools for accessing sponsor content customized for a user to display one or more promotions and advertisements available for the user, the sponsor content customized for the user based at least in part upon one or more rules in a meta-knowledge rule base of the system, data from the personal profile for the user, and/or the user's system use data;
the tool pallet further comprising one or more tools for accessing one or more moderated forums in the system that are configured to accept user forum entries, the moderated forums are configured to accept user input postings, the moderated forums are vetted by a vetting process of the system by content review to remove inappropriate content and to dynamically categorize user forum entries by topic, the tool pallet configured for providing customized access to one or more moderated forums that the user selects as followed forums;
a contribution link adapted for a user to select to access functionality for contributing editorial content to the system;
one or more editorial content displays for displaying the editorial content in a customized categorized manner for the user, the editorial content customized for the user based at least in part upon one or more rules in the meta-knowledge rule base of the system, data from the personal profile for the user, and/or the user's system use data;
an educational content display comprising background information for users regarding post-secondary education institutions and the admissions process or career offerings and the interviewing process;
a consider content display comprising topical issue-raising content for considerations regarding post-secondary education or career planning, the consider content is customized for the user based at least in part upon one or more rules from the meta-knowledge rule base, data from the user personal profile and the user system use data;
an explore content display comprising one or more suggestions and resources for researching post-secondary education institution or employer topics, the explore content is customized for the user based at least in part upon one or more rules from the meta-knowledge rule base, the user personal profile data and the user system use data;
an act content display comprising one or more tools or worksheets selected for the user to complete, the act content display comprising one or more act content tasks, the act content display customized for the user based at least in part upon one or more rules from the meta-knowledge rule base, the user personal profile data and the user's system use data, the tools selected from the group essentially consisting of a college fit worksheet, a budget worksheet and a job evaluation worksheet;
an organize content display comprising one or more calendar entries for calendaring the act content tasks for the post-secondary education or career decision-making, the organize content topically categorized to dynamically categorize organize content entries by topic based upon content tagging based upon one or more rules from the meta-knowledge rule base, data from the user personal profile, and/or information from an activity monitor monitoring user system use;
an opinions content display comprising one or more opinion content selected from the group consisting essentially of counseling advice, advisor opinions, peer opinions, alumni opinions and student opinions, the opinions content topically categorized to dynamically categorize opinions content entries by topic based upon content tagging based upon one or more rules from the meta-knowledge rule base, data from the user personal profile, and/or information from an activity monitor monitoring user system use; and
a subject bar comprising one or more links for accessing secondary considerations for post-secondary education decision-making comprising sporting team try-out data, scholarship data, geographic location of the post-secondary education institution, music program auditions data, nearby amenities data or local community data, or comprising once or more links for accessing secondary considerations for career decision-making comprising benefits, job scope, geographic location, quality of life in that geographic location, company type, project area of study, project team or potential for promotions, the subject bar being customized for the user based at least in part upon one or more rules from the meta-knowledge rule base, the user personal profile data and the user's system use data.

21. A computer-implemented method for college searching for students to find post-secondary education institution matches using a post-secondary education institution searching system comprising:
receiving, by an interface engine of the post-secondary education institution searching system, user defined search criteria for searching for one or more colleges, the search criteria not comprising user selection of search criteria pre-listed by the system, the search criteria comprising one or more user generated and input search terms, the search criteria further comprising data input to one or more tools or worksheets of the post-secondary education institution searching system;
receiving, by the interface engine of the post-secondary education institution searching system, user defined ranked weighting of the search criteria, the ranked weighting assigning relative values to the search criteria;
searching for colleges in a college database of the system that substantially match the user input search terms by a processor of the interface engine matching one or more colleges in the college database to the user generated and input search terms, based upon one or more rules of a meta-knowledge rules base and the user input search terms, the system applies the user input search terms and searches with the interface engine the college database located in a long-term memory, for colleges substantially matching the user defined search terms; and
displaying customized search results in an order of relevance based upon the ranked weighing of the search terms, the customized search results comprising matches in the college database, the customized search results listed on a dynamic graphical user interface of the system in an order based upon the ranked weighting.

22. The method of claim 21, further comprising:
receiving, by the interface engine of the post-secondary education institution searching system, a change to the user defined ranked weighting of the search criteria, the changed ranked weighting assigning new relative values to the search criteria; and
displaying new customized search results, based upon the new ranked weighing of the search terms.

23. The method of claim 21, the display of customized search results further comprising calendar data for college admissions events of each matched college.
